(19) United States
(12) Patent Application Publication
(10) Pub. No.: US 2008/0309618 A1
(43) Pub. Date: Dec. 18, 2008

(54) METHODS AND SYSTEMS FOR CONTROLLING AN INPUT DEVICE, FOR GENERATING COLLISION DATA, AND FOR CONTROLLING A CAMERA ANGLE

(76) Inventor: Kazuyuki OKADA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/134,896

(22) Filed: Jun. 6, 2008

Related U.S. Application Data
(60) Provisional application No. 60/929,143, filed on Jun. 12, 2007.
(60) Provisional application No. 60/929,144, filed on Jun. 13, 2007.

(51) Int. Cl. G06F 3/033

(52) U.S. Cl. 345/157

(57) ABSTRACT

A method includes sampling a controller's pointer position and tilt angle, wherein the pointer position is based on an interaction between the controller and a screen of a monitor; calculating a center region tilt value based on the sampling; calculating upper and lower tilt value limits based on the calculated center region tilt value; and storing the calculated values so that a video game system can process a virtual pointer Y-axis value based on a game player's use of the controller.

### BENEFIT OF PRIORITY

This application claims the benefit of U.S. Provisional Application No. 60/929,143, filed Jun. 12, 2007, and U.S. Provisional Application No. 60/929,144, filed Jun. 13, 2007, both of which are incorporated herein by reference in their entirety.

### BACKGROUND

1. Field of the Invention

Embodiments of the invention relate to methods and systems for controlling an input device, for generating collision data, and for controlling a camera angle.

2. Discussion of Related Art

Video game consoles have been around since the early 1970's. One of the more popular games during this generation was Pong, a ping-pong type of video game. Since this time, the video game consoles providing these video games have gone through quite a transformation.

Today, the three major video game consoles include the Sony Playstation 3, the Microsoft 360, and the Nintendo Wii. Each of these consoles has been very successful. For example, the Nintendo Wii has been very successful due in part to its wireless controller, the Wii Remote.

The Wii Remote is used as a handheld pointing device and detects movement in three dimensions. It uses a combination of built-in accelerometers and infrared detection to sense its position in (3D) space when pointed at LEDs within a Sensor Bar of the Wii console. This design allows users to control the game by using physical gestures as well as traditional button presses.

The Wii Remote senses light from the LEDs arranged within the Sensor Bar. The Sensor Bar is required when the Wii Remote is controlling up-down, left-right motion of a cursor on the TV screen to point to menu options or objects such as enemies in first person shooter-type games. While the Wii video game console, having the Wii Remote and the Sensor Bar, provides a game player with a good gaming experience, it is limited by having to rely mostly on the Sensor Bar to detect pointer positioning. For example, if a player moves the pointer of the Wii Remote to a position outside of the optical detection area sensed by the Sensor Bar, it cannot detect the optical data provided by the Wii Remote. The game player would not have the ability to control the game if the pointer is outside of this area.

Accordingly, there exists a need to provide a game player with a better game playing experience.

### SUMMARY

Some embodiments of the invention provide a method including sampling a controller's pointer position and tilt angle, wherein the pointer position is based on an interaction between the controller and a screen of a monitor; calculating a center region tilt value based on the sampling; calculating upper and lower tilt value limits based on the calculated center region tilt value; and storing the calculated values so that a video game system can process a virtual pointer Y-axis value based on a game player's use of the controller.

Some embodiments describe a method including sampling a controller's pointer position and tilt angle, wherein the pointer position is based on an interaction between the controller and a screen of a monitor; calculating a center region tilt value based on the sampling; calculating upper and lower tilt value limits based on the calculated center region tilt value; determining a Y-axis value based on the calculations; determining an X-axis value based on the calculations; and storing the determined X and Y-axis values so that a video game system can process a virtual pointer X-axis value and Y-axis value based on a game player's use of the controller.

Some embodiments consistent with the invention provide a computer readable medium storing instructions that, when executed by a computer, cause the computer to perform a method for processing a position based on positioning of a controller. These instructions cause the computer to perform a method including sampling the controller's pointer position and tilt angle, wherein the pointer position is based on an interaction between the controller and a screen of a monitor; calculating a center region tilt value based on the sampling; calculating upper and lower tilt value limits based on the calculated center region tilt value, and storing the calculated values so that a video game system can process a virtual pointer Y-axis value based on a game player's use of the controller.

Some embodiments consistent with the invention provide a computer readable medium storing instructions that, when executed by a computer, cause the computer to perform a method for processing a position based on positioning of a controller. These instructions cause the computer to perform a method including sampling the controller's pointer position and tilt angle, wherein the pointer position is based on an interaction between the controller and a screen of a monitor; calculating a center region tilt value based on the sampling, calculating upper and lower tilt value limits based on the calculated center region tilt value; determining a Y-axis value based on the calculations; determining an X-axis value based on the calculations; and storing the determined X and Y-axis values so that a video game system can process a virtual pointer X-axis value and Y-axis value based on a game player's use of the controller.

### BRIEF DESCRIPTION OF THE DRAWINGS

FIG. 1 is a block diagram of an exemplary video game device.

FIG. 2A illustrates an exemplary system including a screen of a monitor and an exemplary LED module coupled to a video game device consistent with some embodiments of the present invention.

FIG. 2B illustrates an exemplary embodiment on how movement of a cursor along a cursor path is performed using an optical sensor and an acceleration sensor of a controller consistent with some embodiments of the present invention.

FIG. 3A provides an exemplary embodiment illustrating an infrared pattern provided by an LED module consistent with some embodiments of the present invention.

FIG. 3B illustrates tilting the controller with respect to a screen consistent with some embodiments of the present invention.

FIG. 3C illustrates how sampled tilt data, from an acceleration sensor of the controller, can be normalized based on the controller's positioning consistent with some embodiments of the present invention.

FIG. 4 illustrates a flowchart of an exemplary method for calculating a virtual pointer Y-axis value using the acceleration sensor and/or gyro sensor of the controller consistent with some embodiments of the present invention.

FIG. 5 illustrates a flowchart of an exemplary method for sampling a virtual pointer position consistent with some embodiments of the present invention.

FIG. 6 illustrates a flowchart of an exemplary method for calculating a tilt angle of the controller consistent with some embodiments of the present invention.

FIG. 7 illustrates an exemplary method for calculating a virtual pointer X-axis value using the acceleration sensor and/or gyro sensor of the controller consistent with some embodiments of the present invention.

FIG. 8 illustrates a technique for defining a 3D path based on generating 2D planar segments.

FIG. 9A illustrates an exemplary 3D segment that can be used to improve the technique shown in FIG. 8.

FIG. 9B illustrates multiple 3D segments joined together so an avatar can travel along a set of connected pathline planes.

FIG. 10 illustrates an exemplary overhead view of a predetermined path.

FIG. 11 illustrates an embodiment of video game device memory, which stores floor, ceiling, and wall data for each 3D segment consistent with some embodiments of the present invention.

FIGS. 12A-C illustrate exemplary embodiments of an avatar traveling through a 3D world.

FIG. 13 illustrates an embodiment in which a predetermined path includes a middle line.

FIG. 14 illustrates an example of how a camera angle can be altered based on an avatar's position within the predetermined path.

### DETAILED DESCRIPTION OF THE DRAWINGS

Reference will now be made in detail to the exemplary embodiments of the invention, the examples of which are illustrated in the accompanying drawings. Wherever possible, the same reference numbers will be used throughout the drawings to refer to the same or like parts.

### Hardware Components

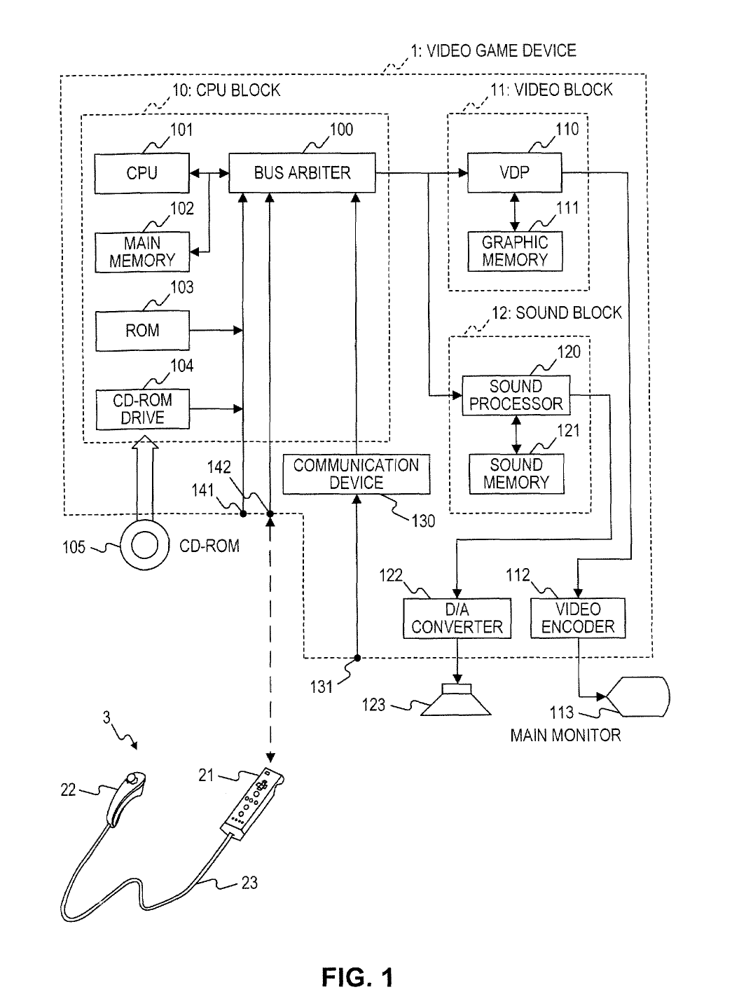

FIG. 1 is a block diagram of an exemplary video game device 1. Video game device 1 includes a CPU block 10, a video block 11, a sound block 12, and a communication device 130. FIG. 1 also illustrates a controller 3 for use to manipulate in order to play a game executed by video game device 1.

CPU block 10 includes a bus arbiter 100, a CPU 101, a main memory 102, a boot ROM 103, and a CD drive 104. Bus arbiter 100 can transmit and receive data by assigning a bus occupancy time to the devices mutually connected via one or more busses. CPU 101 can access main memory 102, boot ROM 103, CD drive 104, video block 11, sound block 12, backup memory (not illustrated), and a controller 3 though a receiving unit 142. Receiving unit 142 may, for example, be provided as a wireless interface or a wired communication port.

Video block 11 includes, among other things, a video display processor (VDP) 110, a graphic memory 111, and a video encoder 112 (illustrated outside of video block 11). Sound block 12 includes, among other things, a sound processor 120, a sound memory 121, and a DIA converter 122 (illustrated outside of sound block 12).

CPU 101 executes an initialization program stored in boot ROM 103 when power is turned on, initializes device 1, and, when CPU 101 detects that, e.g., a CD 105 has been installed in CD drive 104, transfers the operating system program data stored in CD 105 to main memory 102.

Thereafter, CPU 101 operates in accordance with the operating system, and continues to transfer and execute the program of the game processing method stored in CD 105 to main memory 102, according to the some embodiments of the invention.

Further, CPU 101 transfers game processing image data to graphic memory 111, and sound data to sound memory 121. The processing steps of the program executed by CPU 101 include input of operation signals from controller 3 and communication data from communication device 130, command output to controller 3 based on such input, and control of image outputs to be conducted by video block 11 and of sound outputs to be conducted by sound block 12.

Main memory 102 can store the aforementioned operating system program data and other programs, and also provide a work area for static variables and dynamic variables. Boot ROM 103 is a storage area of an initial program loader.

CD drive 104 is capable of receiving CD 105, and, when CD 105 is installed therein, CPU 101 reads data provided on CD 105. CPU 101 outputs the read data and transfers the data pursuant to the control of CPU 101.

CD 105 stores the program for making video game device 1 execute the game processing, image data for image display, and sound data for sound output The recording medium is not limited to CD 105, and may be other various machine-readable recording mediums. It is also possible to transfer data groups stored in CD 105 to main memory 102 or, via communication device 130, to a remote memory device of a game supply server connected to an input port 131. This type of setting enables data transmission from secure disks of remote servers and the like.

Graphic memory 111 stores image data read from CD 105, as described above. VDP 110 reads image data necessary for image display among the image data stored in graphic memory 111, and executes coordinate conversion (geometry operation), texture zapping processing, display priority processing, shading processing, and any other necessary display processing in accordance with the information necessary for the image display supplied from CPU 101. This necessary information can include, for example, command data, viewpoint position data, light source position data, object designation data, object position data, texture designation data, texture density data, and visual field conversion matrix data. Further, it is possible to structure CPU 101, for example, to conduct the processing of the aforementioned coordinate conversion and the like. In other words, the respective processing steps may be assigned to the respective devices in consideration of the operation capacity of the devices. Video encoder 112 can convert the image data generated by VDP 110 into prescribed television signals, for example, in an NTSC format and output such signals to an externally connected main monitor 113.

Sound memory 121 stores sound data read from CD 105. as described above. Sound processor 120 reads sound data such as waveform data stored in sound memory 121 based on the command data supplied from CPU 101 and conducts, for example, various effects processing and digital/analog (D/A) conversion processing pursuant to a digital signal processor (DSP) function. D/A converter 122 converts the sound data generated by sound processor 120 into analog signals, and output such signals to an externally connected speaker 123.

Communication device 130 is a device, e.g., a modem or terminal adapter, that is connectable to video game device 1, and functions as an adapter for connecting video game device 1 to external circuits. Moreover, communication device 130 receives data transmitted from the game supply server connected to a public circuit network, and supplies such data to the bus of CPU block 10. Such public circuit network may be accessed as a subscription circuit, private line, wired or wireless line, etc.

Video game device 1 is connected to receiving unit 142 via a connection terminal. Receiving unit 142 receives transmission data, which is wirelessly transmitted from controller 3, thereby enabling controller 3 and video game device 1 to be connected to each other by wireless communication. A game player playing with video game device 1 can enjoy the game by operating controller 3 while watching the game image displayed on monitor 113. For example, controller 3 can be the controller described in U.S. Application No. 11/404,844 (U.S. Publication No. 2007/0049374), titled “Game System and Storage Medium Having Game Program Stored Thereon,” and/or U.S. application Ser. No. 11/504,086 (U.S. Publication No. 2007/0072680), titled “Game Controller and Game System,” which are incorporated herein by reference.

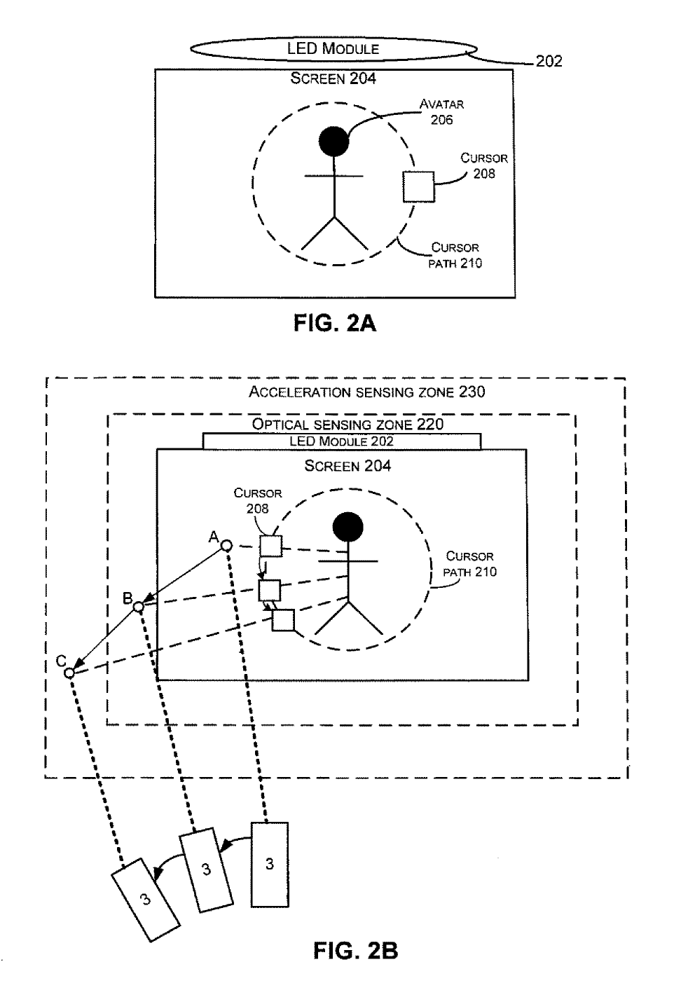

Controller 3 wirelessly transmits the transmission data from a communication section included therein to video game device 1 connected to receiving unit 142, using the technology of, for example, Bluetooth™. Controller 3 can include two control units, a core unit 21 and a subunit 22, connected to each other by a flexible connecting cable 23. While this embodiment illustrates that controller includes two units, one of ordinary skill in the art will now appreciate that controller 3 can be a single device or be multiple devices. Controller 3 is an operation means for mainly operating a player object appearing in a game space displayed on monitor 113. Core unit 21 and subunit 22 each includes an operation section such as a plurality of operation buttons, a key, a joystick, among others. Core unit 21 includes an optical sensor for capturing an image viewed from core unit 21, one or more acceleration sensors, and/or a gyro sensor for detecting rotation (or angular rate) around at least one axis defined by a gyroscopic element therein. As an example of an imaging target of the optical sensor, and as more fully described below with reference to FIG. 2B, one or more LED modules can be provided in the vicinity of a display screen of monitor 113. The one or more LED modules each outputs infrared light away from monitor 113. Although in the present embodiment core unit 21 and subunit 22 are connected to each other by connecting cable 23, subunit 22 may have a wireless unit, thereby eliminating the need for connecting cable 23. For example, subunit 22 could have a Bluetooth™ unit as the wireless unit, whereby subunit 22 can transmit operation data to core unit 21.

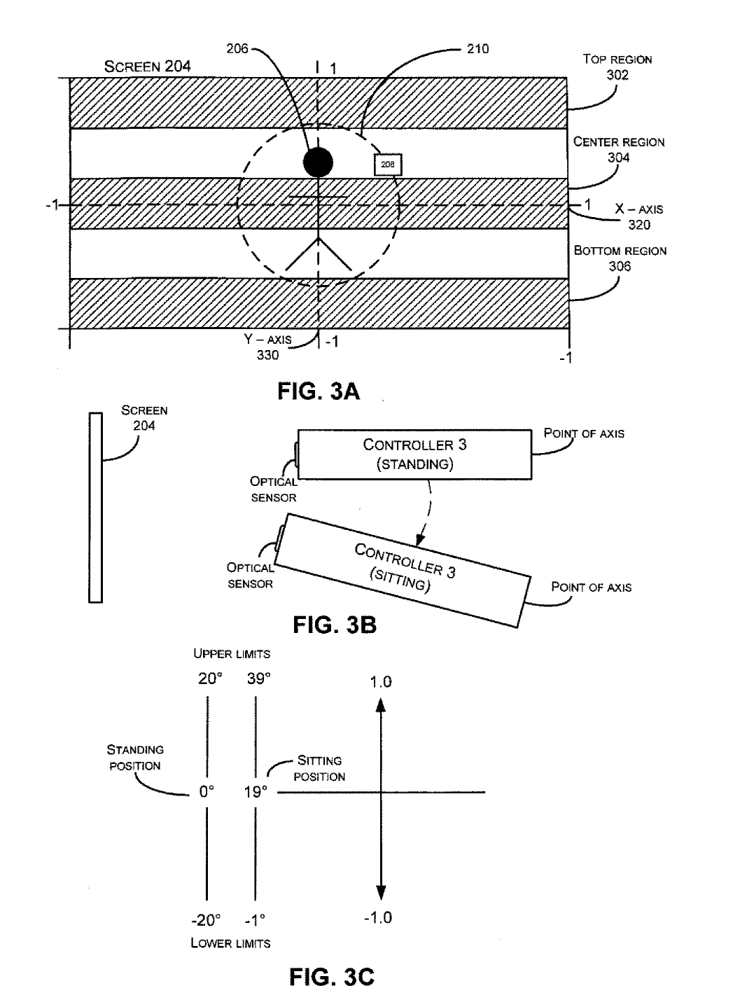

Core unit 21 provides, on a front surface thereof, an image pickup element included in the optical sensor. The optical sensor provides data that assists in analyzing image data captured by core unit 21 and detecting a center region corresponding to monitor 113, e.g., a center region 304 of FIG. 3A, based on a sizeable area having a high brightness from the analyzed image data. The optical sensor may have, for example, a maximum sampling period of about 200 frames/sec., and therefore can trace and analyze even a relatively fast motion of core unit 21.

The optical sensor includes an infrared filter, a lens, an image pickup element, and an image processing circuit. The infrared filter allows only infrared light to pass therethrough, among light incident on the front surface of core unit 21. The lens collects the infrared light that has passed through the infrared filter and outputs the infrared light to the image pickup element. The image pickup element is a solid-state imaging device such as, for example, a CMOS sensor or a CCD. The image pickup element captures an image of the infrared light collected by the lens. Accordingly, the image pickup element captures an image of only the infrared light that has passed through the infrared filter and generates image data. The image data generated by the image pickup element is processed by the image processing circuit. Specifically, the image processing circuit processes the image data obtained from the image pickup element, identifies a spot thereof having a high brightness, and outputs process result data representing the identified position coordinates and size of the area to receiving unit 142.

The optical sensor is fixed to the housing of core unit 21. The imaging direction of the optical sensor can be changed by changing the direction of the housing of core unit 21. The housing of core unit 21 is connected to subunit 22 by the flexible connecting cable 23, and therefore, the imaging direction of the optical sensor is not changed by changing the direction and position of subunit 22. As described later in detail, a signal can be obtained in accordance with the position and the motion of core unit 21 based on the process result data outputted by the optical sensor.

The above noted one or more acceleration sensors of core unit 21 may be provided as a three-axis acceleration sensor. Further, subunit 22 can also include a three-axis acceleration sensor. Each of the three-axis acceleration sensors can detect a linear acceleration in three directions, i.e., the up/down direction, the left/right direction, and the forward/backward direction. Alternatively, a two-axis acceleration detection sensor, which detects only a linear acceleration along each of the up/down and left/right directions (or other pair of directions), may be used in another embodiment depending on the type of control signals used in the game process. For example, the three-axis acceleration sensors or the two-axis acceleration sensors may be of the type available from Analog Devices, Inc. or STMicroelectronics N.V. Each of the acceleration sensors could be of an electrostatic capacitance (capacitance-coupling) type that is based on silicon micro-machined MEMS (Micro Electro Mechanical Systems) technology. However, any other suitable acceleration detection technology (e.g., piezoelectric type or piezoresistance type) now existing or later developed may be used to provide the three-axis acceleration sensors or two-axis acceleration sensors.

As one skilled in the art will now understand for the purpose of this embodiment, the acceleration detection means, as used in the acceleration sensors, can detect acceleration (linear acceleration) along a straight line corresponding to each axis of the acceleration sensor. In other words, each of the direct outputs of the acceleration sensors generates signals indicative of linear acceleration (static or dynamic) along each of the two or three axes thereof. As a result, the acceleration sensors cannot directly detect movement along a non-linear (e.g., arcuate) path, rotation, rotational movement, angular displacement, tilt, position, or attitude.

However, through additional processing of the acceleration signals output from each of the acceleration sensors, additional information relating to core unit 21 and subunit 22 can be inferred or calculated, as one skilled in the art will understand from the description herein. For example, by detecting static acceleration (i.e., gravity), the outputs of the acceleration sensors can be used to infer tilt of the object (core unit 21 or subunit 22) relative to the gravity vector by correlating tilt angles with detected acceleration. In this way, the acceleration sensors can be used in combination with the video game device 1 (or another processor) to determine tilts, altitudes, or positions of core unit 21 and subunit 22. Similarly, various movements and/or positions of core unit 21 and subunit 22 can be calculated or inferred through processing of the acceleration signals generated by the acceleration sensors when core unit 21, containing the acceleration sensor, or subunit 22, containing the acceleration sensor, is subjected to dynamic accelerations by, for example, the hand of a user, as described herein.

In another embodiment, each of the acceleration sensors may include an embedded signal processor or other type of dedicated processor for performing any desired processing of the acceleration signals outputted from the acceleration sensor prior to outputting signals to video game device 1. For example, the embedded or dedicated processor could convert the detected acceleration signal to a corresponding tilt angle when the acceleration sensor is intended to detect static acceleration (i.e., gravity). Data representing the acceleration detected by each of the acceleration sensors is transmitted to receiving unit 142 from controller 3.

In another exemplary embodiment, at least one of the acceleration sensors may be replaced or used in combination with a gyro-sensor of any suitable technology incorporating, for example, a rotating or vibrating element. The gyro-sensor of controller 3 can include any suitable technology incorporating, for example, a rotating or vibrating element. Exemplary gyro-sensors that may be used in this embodiment are available, for example, from Analog Devices, Inc. The gyro-sensor is capable of directly detecting rotation (or angular rate) around at least one axis defined by the gyroscopic element therein.

When using a gyro-sensor, video game device 1 can initialize the value of the tilt at the start of the detection. Then, video game device 1 can integrate the angular rate data generated by the gyro-sensor. Next, video game device 1 can calculate a change in tilt from the initialized value of the tilt. In this case, the calculated tilt corresponds to an angle. Therefore, the calculated tilt can be represented as a vector. Thus, without initialization, an absolute direction can be determined with an acceleration detection sensor. The calculated value of the gyro sensor is the tilt of the angle when the gyro sensor is used. In some embodiments, an acceleration sensor can be used to combination with the gyro sensor to provide data to video game device 1. For simplification purposes, references herein to data generated by the gyro sensor or by acceleration sensor can include data from one of or both the gyro sensor and the acceleration sensor. Furthermore, one of ordinary skill in the art will now appreciate that controller 3 can process at least some of these steps by itself or in combination with video game device 1.

### Controlling an Input Device

FIG. 2A illustrates an exemplary screen 204 of monitor 113 and an exemplary LED module 202 coupled to video game device 1. In this particular embodiment, screen 204 displays an avatar 206, a cursor 208, and a cursor path 210. In some embodiments, cursor 208 and/or cursor path 210 may be invisible to a game player. In some embodiments, cursor 208 and/or cursor path 210 may not exist. In this particular embodiment, controller 3 works with LED Module 202 to determine the location of cursor 208 along cursor path 210 so that avatar 206 can move in the direction of cursor 208.

A game player can control the movement of avatar 206, for example, if the connecting subunit 22 is not connected to core unit 21, by using the pointing function of core unit 21 (through use of the optical sensor) and acceleration sensor. By providing a cursor between avatar 206 and the pointing location of core unit 21, video game device 1 allows a game player to easily follow avatar 206. If the game player points to a location, i.e., a pointer location, inside cursor path 210, the video game device can display cursor 208 within cursor path 210, which could indicate that avatar 206 is subtly moving.

FIG. 2B illustrates an exemplary embodiment of how this movement is performed using the optical sensor and the acceleration sensor of controller 3. Based on controller 3 and LED Module 202, there are three zones that can be detected by video game device 1. These zones include screen zone 204, optical sensing zone 220, and acceleration sensing zone 230. When a game player points controller 3 at screen zone 204 or optical sensing zone 220, video game device 1 can use data from both the optical sensor and the acceleration sensor. But when the game player points controller 3 outside of optical sensing zone 220 and still within acceleration sensing zone 230, video game device 1 can use only the acceleration sensor (and/or gyro sensor) data from controller 3. In some embodiments, the color of cursor 208 may change based on whether the pointer location is located within screen zone 204, optical sensing zone 220, and/or acceleration sensing zone 230.

In this particular embodiment, allowing a game player the ability to move the controller outside of optical sensing zone 220 still allows a player the ability to control cursor 208 along cursor path 210 and hence, to control the movement of avatar 206 within the game. For example, a user can move the pointer location from position A on screen zone 204 to position B outside of screen zone 204 and still be within optical sensing zone 220. The optical sensor and the acceleration sensor can generate data for controller 3, which provides the generated data to video game device 1. Accordingly, video game device 1 can adjust the position of cursor 208 from the position corresponding to pointer position A to the location corresponding with pointer position B along cursor path 210. In some embodiments, the optical sensor and the acceleration sensor can further generate additional data relating to the speed and acceleration of the changed pointer location. This additional data can alter the characteristics of the avatar so that, for example, the avatar can speed up or slow down based on the additional data.

When the game player moves controller 3 to point from pointer position B to pointer position C, controller 3 can provide optical sensor data up to the point where the optical sensing zone 220 ends. After the pointer location moves outside of the optical sensing zone 220, but still within acceleration sensor zone 230, the acceleration sensor (and/or gyro sensor) can provide data so that the game player can still control the position of cursor 208 along cursor path 210. The acceleration sensor can generate data regarding the location of position C. Controller 3 can provide this data to video game device 1, which updates the position of cursor 208 along cursor path 210. Further, this data can include additional information, such as speed and acceleration, that would alter the characteristics (e.g., speed, etc.) of avatar 206.

For example, to determine positioning of the pointer location within screen zone 204 (or even optical sensing zone 220), LED module 202 provides an infrared pattern within screen zone 204 (or optical sensing zone 220). FIG. 3A provides an exemplary embodiment illustrating the pattern provided by LED module 202. The pattern includes a top region 302, a center region 304, and a bottom region 306. These regions can be used to set up an X-axis 320 and a Y-axis 330.

As a user moves the pointer location of controller 3 though one of these regions or from one region to the next, video game device 1 can adjust the positioning of the cursor 208 along cursor path 210. Video game device 1 determines the pointer location by sampling the positioning data (optical sensor data, gyro sensor data, and/or accelerometer data) at a rate of, for example, 30 times per second. One or more of these samples can be stored in a data block so that video game device 1 can average the data out. For example, a game player may sit down from a standing position while still playing a game. By sitting down, the tilt of the controller would most likely change with respect to screen 204 (for example, see FIG. 3B). In FIG. 3B, if the player sits down, the player will likely have to tilt controller 3 higher up towards screen 204 in order to manipulate the pointer location. This would affect the tilt angle and position of controller 3 for sampling purposes.

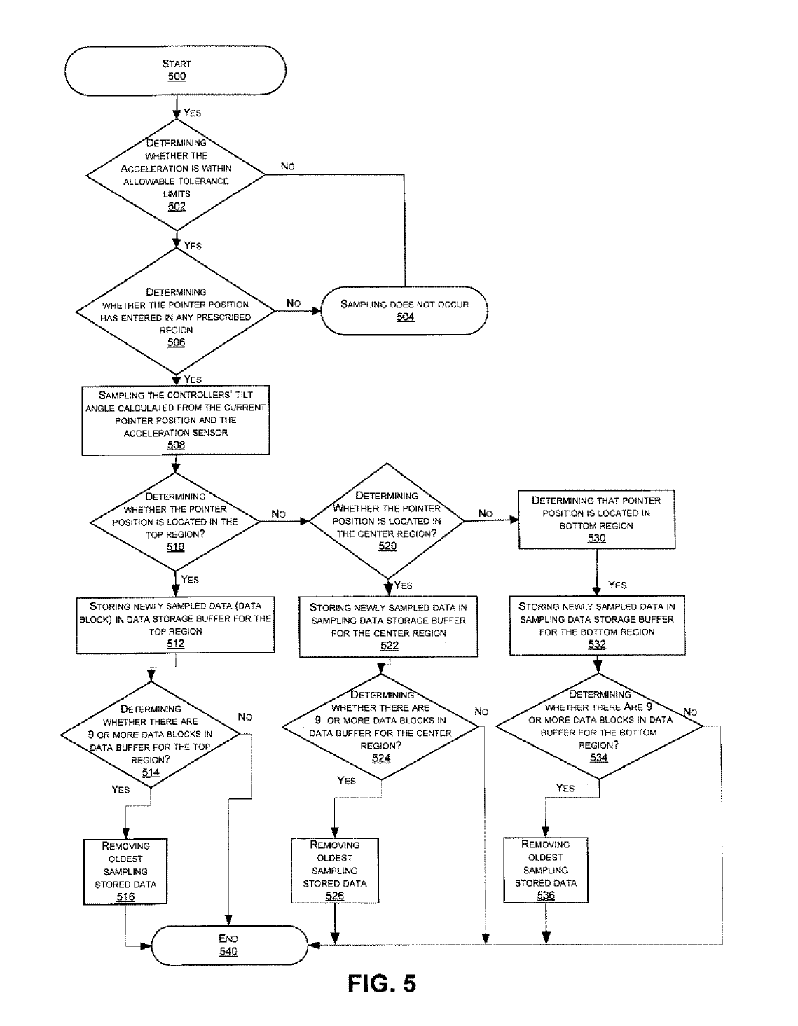

By sampling and averaging the positioning data, video game device 1 can compensate for the player's movement without substantially affecting game play. FIG. 3C illustrates how the sampled tilt data from the acceleration sensor can be normalized based on the controller's position according to the game player. For example, a game player could be standing while playing the game such that the tilt angle of controller 3 is at 0°. When the player sits down, the controller may have to be tilted up towards the screen of monitor 113 at a tilt angle of, for example, 19°. Any deviations from this 19° would result in player movement. Without the normalization of this tilt data, the play of the game could be drastically affected. An exemplary sampling process corresponding to FIG. 3A is further illustrated in FIG. 5.

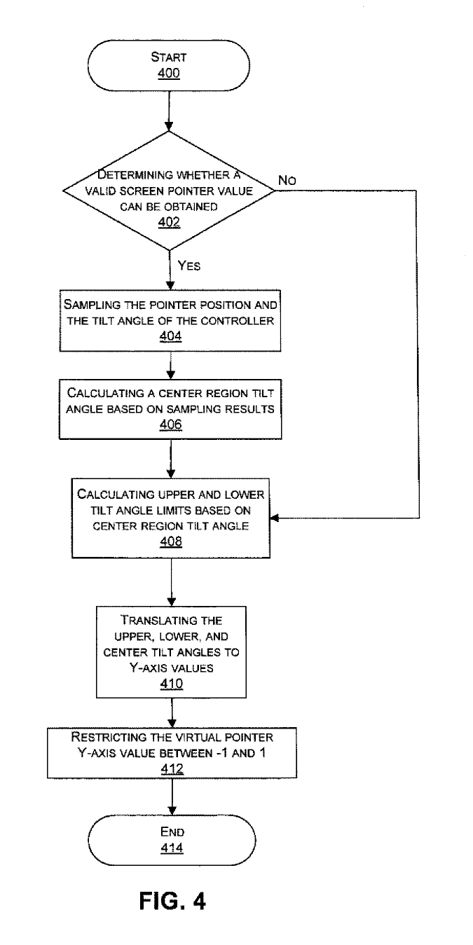

FIG. 4 illustrates a flowchart of an exemplary method for calculating a virtual pointer Y-axis value using an acceleration sensor and/or gyro sensor. It will now be appreciated by one of ordinary skill in the art that the illustrated procedure can be altered to delete steps, move steps, or further include additional steps. After an initial start step 400, a video game system (e.g., video game device 1 and/or controller 3) determines (402) whether a valid screen pointer value can be obtained. If not, the method proceeds to step 408, described below. On the other hand, if a valid screen pointer value can be obtained, the video game system can sample (404) a pointer position and a tilt angle of controller 3. Sampling step 404 can be an exemplary sampling method illustrated in FIG. 5.

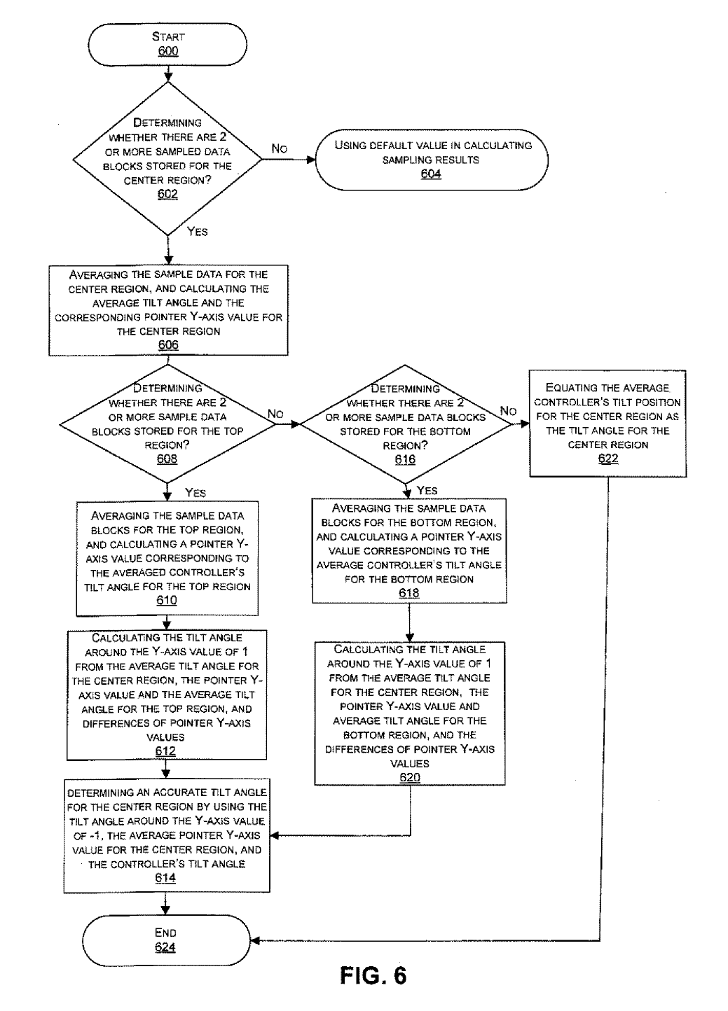

After sampling the pointer position and the tilt angle, the video game system calculates (406) the controller's tilt angle, corresponding to center region 304, from the sampled screen pointer positions. This step allows the video game system to normalize the tilt angle based on, for example, whether a game player is sitting versus standing while playing the game. Calculating step 406 can be an exemplary calculating method illustrated in FIG. 6.

After calculating the tilt angle from center region 304, the video game system calculates the upper and lower tilt angle limits by adding a prescribed maximum tilt angle to the calculated center region tilt angle to determine an upper tilt angle and subtracting a prescribed minimum tilt angle from the calculated center region to determine a lower tilt angle. For example, as illustrated in FIG. 3C, if the game player is sitting while playing the game, the calculated center region 304 would be 19°. The maximum and minimum tilt angles could be 20° and 20°, respectively. The upper tilt angle would then be 39°=19° (center region tilt angle)+20° (prescribed maximum tilt angle). The lower tilt angle would be −1°=19° (center region tilt angle)−20° (prescribed minimum tilt angle). One of ordinary skill in the art will now appreciate that the maximum and minimum tilt angles could be any number.

Then, the video game system translates (410) the upper, lower, and center region tilt angles into their corresponding Y-axis values. For example, as illustrated in FIGS. 3A and 3C, center region tilt angle of 19° would correspond to a Y-axis value=0. Upper tilt angle 39° would correspond to a Y-axis value of 1 while lower tilt angle −1° would correspond to a Y-axis value of −1. After translating these tilt angles into their corresponding Y-axis values, the video game system can then restrict (412) the virtual pointer Y-axis value between −1 and 1 so that video game system 1 can properly render the movement of avatar 206. Even if the actual tilt angle exceeds the maximum tilt angle, the Y-axis value would still be restricted to 1. The same would hold true for the minimum tilt angle. Finally, the method can proceed to end (414).

FIG. 5 illustrates a flowchart of an exemplary method for sampling a virtual pointer position. For example, this sampling of the virtual pointer position could be sampling step 404 of FIG. 4. It will now be appreciated by one of ordinary skill in the art that the illustrated procedure can be altered to delete steps, move steps, or further include additional steps. After an initial start step 500, a video game system determines (502) whether an acceleration of the pointer is within allowable tolerance limits. If not, the method proceeds to step 504 where the video game system does not sample the pointer position. On the other hand, if the acceleration of the pointer position movement is within allowable tolerance limits, the video game system determines (406) whether the pointer position has entered any prescribed region (e.g., top region 302, center region 304, or bottom region 306 as illustrated in FIG. 3A). If not, the method proceeds to step 504 where the video game system does not sample the pointer position.

If the pointer position has entered a prescribed region, the video game system samples (508) the controller's tilt angle calculated from the current pointer position and the acceleration sensor. After sampling the controller's tilt angle, the video game system determines (510) whether the pointer position is located in top region 302. If so, the video game system stores (512) the newly sampled data (or data block) in a sampling data storage buffer for top region 302. Next, the video game system determines (514) whether there are nine or more data blocks stored in the data buffer for top region 302. If so, video game system removes (516) one or more of the oldest data blocks until there are 8 data blocks left in the data buffer for top region 302 and the method can proceed to end (540). While 8 data blocks are used in this exemplary embodiment, the data buffer can assign any number of data blocks for this region. If there are less than 9 data blocks stored in data buffer for top region 302, the video game system does not need to remove any data blocks and the method can proceed to end (540).

If it is determined that the pointer position is not located in top region 302 in step 510, the video game system determines (520) whether the pointer position is located in center region 304. If so, the video game system stores (522) the newly sampled data (or data block) in a sampling data storage buffer for center region 304. Next, the video game system determines (524) whether there are nine or more data blocks stored in the data buffer for center region 304. If so, video game system removes (526) one or more of the oldest data blocks until there are 8 data blocks left in the data buffer for center region 304 and the method can proceed to end (540) While 8 data blocks are used in this exemplary embodiment, the data buffer can assign any number of data blocks for this region. If there are less than 9 data blocks stored in data buffer for center region 304, the video game system does not need to remove any data blocks and the method can proceed to end (540).

If it is determined that the pointer position is not located in center region 304 in step 520, the video game system determines (530) that the pointer position is located in bottom region 306. Then, the video game system stores (532) the newly sampled data (or data block) in a sampling data storage buffer for bottom region 306. Next, the video game system determines (534) whether there are nine or more data blocks stored in the data buffer for bottom region 306. If so, video game system removes (536) one or more of the oldest data blocks until there are 8 data blocks left in the data buffer for bottom region 306 and the method can proceed to end (540). While 8 data blocks are used in this exemplary embodiment, the data buffer can assign any number of data blocks for this region. If there are less than 9 data blocks stored in data buffer for bottom region 306, the video game system does not need to remove any data blocks and the method can proceed to end (540).

FIG. 6 illustrates a flowchart of an exemplary method for calculating a tilt angle of a controller based on center region 304 from sampling results. For example, this calculating of the tilt angle could be calculating step 406 of FIG. 4. It will now be appreciated by one of ordinary skill in the art that the illustrated procedure can be altered to delete steps, move steps, or further include additional steps. After an initial start step 600, the video game system determines (602) whether there are two or more sampled data blocks stored for center region 304, such as the data blocks stored in step 522 of FIG. 5. If not, the video game system uses (604) a default value in calculating sample results because samples are few and reliability is low.

If there are two or more sampled data blocks, the video game system averages (606) sample data for center region 304 and calculates the average controller's tilt angle and the corresponding pointer Y-axis value for center region 304. Then the video game system determines (608) whether two or more sampled data blocks are stored for top region 302. If so, the video game system averages (610) the sampled data blocks for top region 302 and calculates a pointer Y-axis value corresponding to the averaged controllers tilt value for top region 302. After averaging the sampled data blocks, the video game system calculates (612) the tilt angle around the Y-axis value of 1 from the average tilt angle for the center region, the pointer Y-axis value and the average tilt angle for top region 302, and the differences between these Y-axis values. The video game system then determines (614) an accurate tilt angle for center region 304 by using a tilt angle around the Y-axis value of −1, the averaged pointer Y-axis value for center region 304, and the tilt angle of controller 3. After determining the accurate tilt angle in step 614, the method can proceed to end (624).

Referring back to step 608, if two or more sample data blocks are not stored in for top region 302, the video game system determines (616) whether there are two or more sampled data blocks stored for bottom region 306. If not, the video game system equates (622) the averaged controller tilt angle for center region 304 as the tilt angle for center region 304 because the sampling numbers for the top and bottom regions are too low. After equating step 622, the method proceeds to end (624).

On the other hand, referring back to step 616, if there are two or more sampled data blocks stored for bottom region 306, the video game system averages (618) the sampled data blocks for bottom region 306 and calculates a pointer Y-axis value corresponding to the averaged controller's tilt value for bottom region 306. After averaging the sampled data blocks, the video game system calculates (620) the tilt angle around the Y-axis value of 1 from the average tilt angle for center region 304, the pointer Y-axis value and the average tilt angle for bottom region 306, and the differences between these Y-axis values. The video game system then determines (614) an accurate tilt angle for center region 304 by using a tilt angle around the Y-axis value of −1, the averaged pointer Y-axis value for center region 304, and the controller tilt angle. After determining step 614, the method can proceed to end (624).

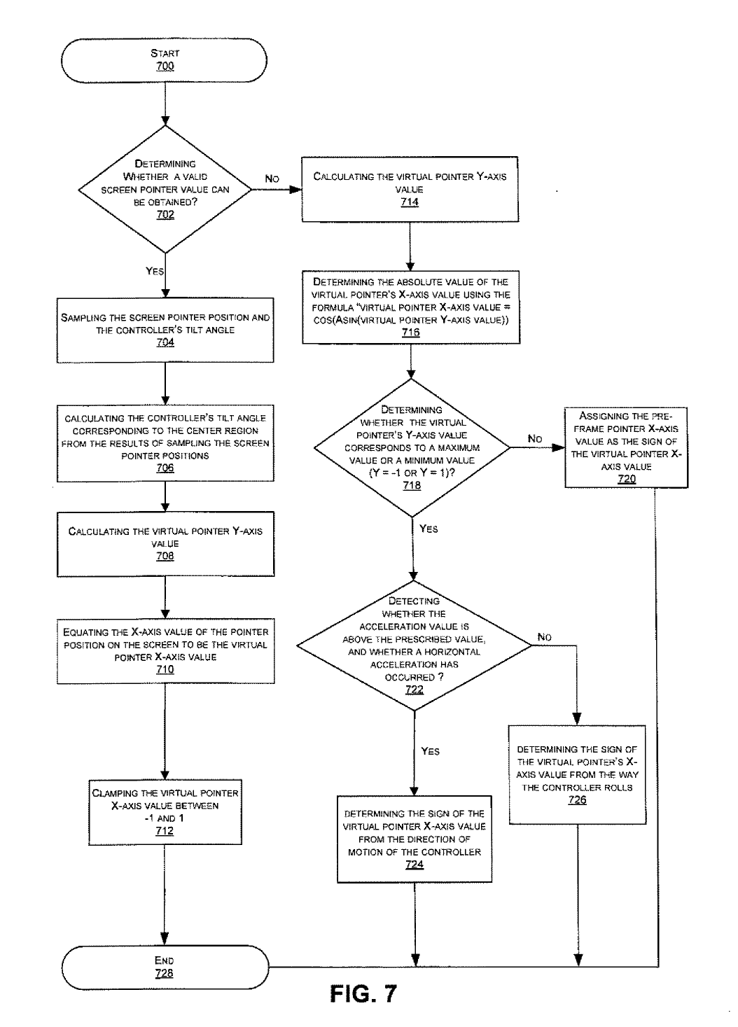

FIG. 7 illustrates an exemplary method for calculating a virtual pointer X-axis value. It will now be appreciated by one of ordinary skill in the art that the illustrated procedure can be altered to delete steps, move steps, or further include additional steps. After an initial start step 700, a video game system determines (702) whether a valid screen pointer value can be obtained. If not, the method proceeds to step 714, described below. On the other hand, if a valid screen pointer value can be obtained, the video game system can sample (704) a pointer position and the tilt angle of controller 3. Sampling step 704 can be the exemplary sampling method illustrated in FIG. 5.

After sampling the pointer position and the tilt angle, the video game system calculates (706) the controller's tilt angle, corresponding to center region 304, from the sampled screen pointer positions. For example, calculation step 706 can be the controller tilt angle calculation performed in FIG. 6. Then, the video game system calculates (708) the virtual pointer's Y-axis value. For example, calculation step 708 can be the Y-axis value calculation performed in FIG. 4. After calculating the virtual pointer's Y-axis value, the video game system equates (710) the X-axis value of the pointer position on the screen to be the virtual pointers X-axis value. Subsequently, the video game system “clamps” (712) the virtual pointer X-axis value between −1 and 1, e.g., as illustrated in FIGS. 3A and 3C so that the video game system can properly render the avatar's movement. Finally, the method can proceed to end (728).

Referring back to determining step 702, if it is determined that a valid screen pointer cannot be obtained, the video game system calculates (714) the Y-axis value of the virtual pointer, corresponding to center region 304, from the sampled screen pointer positions. For example, calculation step 714 can be the controller tilt angle calculation performed in FIG. 6. Then the video game system determines (716) the absolute value of the virtual pointer's X-axis value by using the formula:

virtual pointer X-axis value=cosine(arcsine(virtual pointer Y-axis value)).

After determining the absolute value of the virtual pointer's X-axis value, the video game system determines (718) whether the virtual pointers Y coordinates correspond to a minimum value (e.g., Y=−1) or a maximum value (e.g., Y=1). If not, the video game system assigns (720) a previously-framed pointer X-axis value as the sign (positive/negative) of the virtual pointer X-axis value. This is done by taking the sign of the last X-axis value of the virtual pointer calculated for display on screen 204 and combining the sign with the X-axis value's absolute value provided by determining step 716. After assigning step, the method can proceed to end (728).

Referring back to determining step 718, if the virtual pointer's Y-axis value corresponds to the maximum value or the minimum value, the video game system detects (722) whether the acceleration value provided by the acceleration sensor on controller 3 is above a prescribed value and has a horizontal acceleration (i.e., whether controller 3 has moved in a horizontal direction). If so, the video game system determines (724) the sign (positive/negative) of the virtual pointer's X-axis value from the direction of motion of the controller. After determining step 724, the method can proceed to end (728).

Referring back to detecting step 722, if it is detected that the acceleration value does not exceed above the prescribed value, that there is no horizontal acceleration, or that controller 3 does not move in a horizontal direction, the video game system determines (726) the sign (positive/negative) of the virtual pointer's X-axis value from the way the game player rolls controller 3 (by twisting controller 3, the pointer moves in the direction of motion of controller 3). After determining step 726, the method can proceed to end (728).

### Generating Collision Data

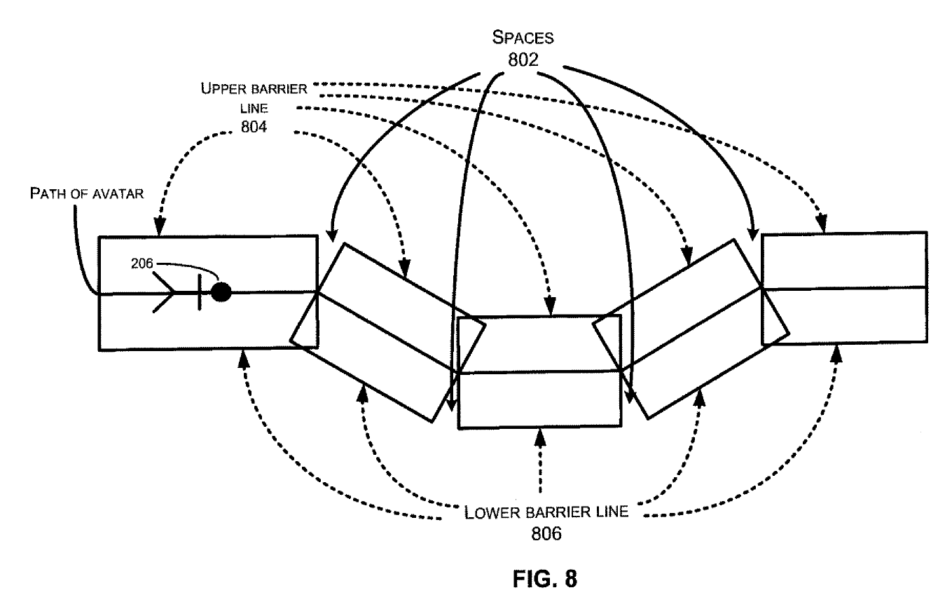

Some games require an avatar to travel in a virtual three-dimensional (3D) world defined by X-, Y-, and Z-axes. Some of this traveling in the virtual world may be based on a predetermined path. Avatar 206 may fly through the 3D world based on the predetermined path. The predetermined path is configured based on the X-axis and the Z-axis and avatar 206 can move freely in the direction of the Y-axis. In some embodiments, other characters within the game, except for the avatar that the player operates, can be moved in the predetermined path, irrespective of the 3 axes. Further, this predetermined path could be further defined by barrier lines so that avatar 206 can travel anywhere along the path as long as it is located within these barrier lines. Advantage may be realized from constructing the game in this way. For example, by defining the path in a 3D world, the game may require less memory and processing because avatar 206 has a limited capability to move throughout the 3D world. The game player would then have the ability to move avatar 206 along the path as long as it did not extend outside of barrier lines, choose the direction (backward and forward) along the path, choose the speed of the avatar, etc. Referring to FIG. 8, the predetermined path can be further defined by an upper barrier line 804 and a lower barrier line 806. Within the game itself, in some embodiments, these lines would be invisible to the game player. These lines are defined so that avatar 206 cannot move outside of these barrier lines. If a game designer models this path by generating 2D planar segments based on the pathline of avatar 206, as illustrated in FIG. 8, errors may occur when avatar 206 or other characters in the game would venture into one of these undefined spaces 802.

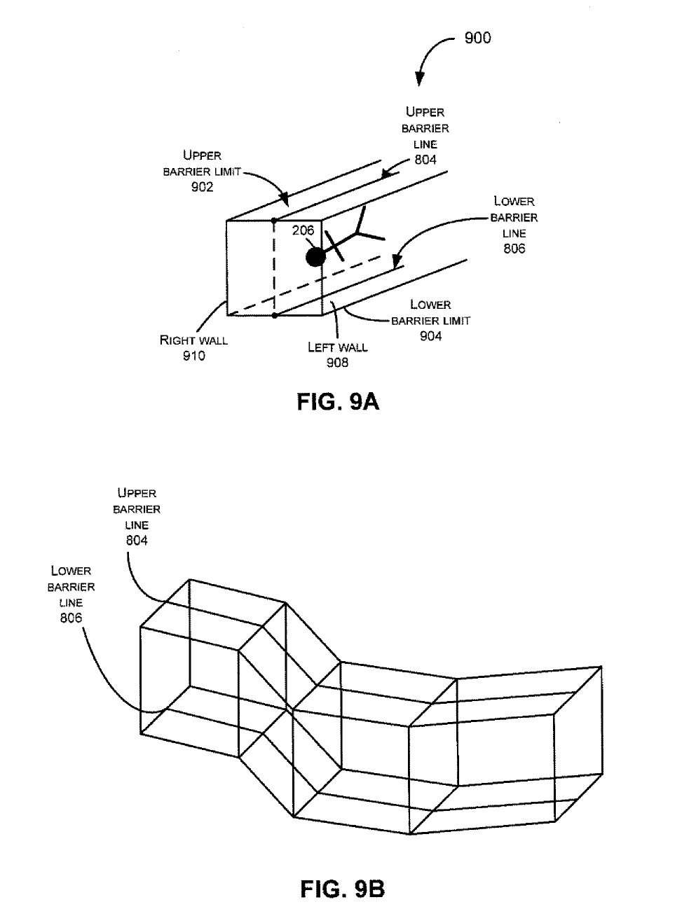

FIG. 9A illustrates an exemplary 3D segment 900 that can be used to obviate errors that may result from the embodiment in FIG. 8. 3D segment 900 can include upper barrier line 804 of an upper barrier limit 902, lower barrier line 806 of a lower barrier limit 904, a left wall 908 connecting the left portions of upper barrier limit 902 and lower barrier limit 904, and a right wall 910 connecting the right portions of upper barrier limit 902 and lower barrier limit 904. In this embodiment, the pathline of avatar 206 is based on the upper barrier line 804 and the lower barrier line 806 of 3D segment 900. This pathline of avatar 206 allows a game player to move avatar 206 along any point within the pathline plane between upper barrier line 804 and lower barrier line 806 of 3D segment 900.

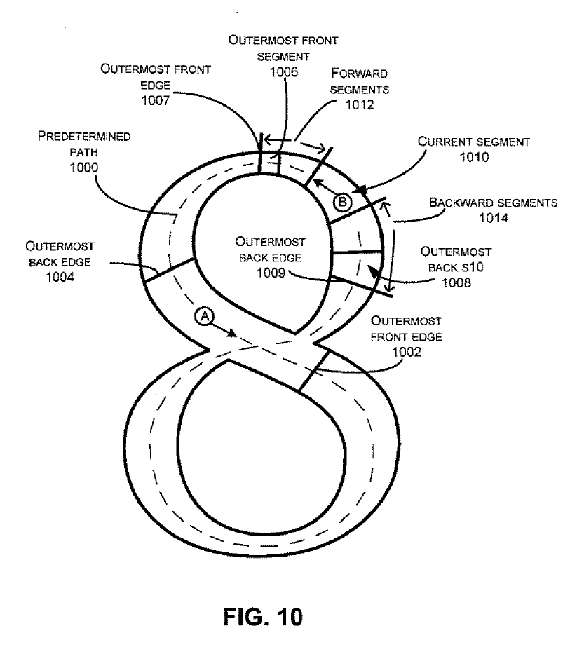

FIG. 9B illustrates multiple 3D segments joined together so that avatar 206 can travel along a set of connected pathline planes. These segments are attributes of avatar 206 and are generated based on the position of avatar 206. For example, FIG. 10 illustrates an overhead view of a predetermined path 1000 within which avatars A and B are traveling. As seen in FIG. 10, path 1000 has a “FIG. 8” configuration. Each avatar has 3D segments that are generated in front and back of the avatar. For example, avatar A is provided with all 3D segments extending from outermost front edge 1002 to outermost back edge 1004. Further, avatar B is provided with current segment 1010, forward segments 1012, and backward segments 1014 extending from an outermost front segment 1006 of forward segments 1012 to an outermost back segment 1008 of backward segments 1014. Outermost front segment 1006 extends to an outermost front edge 1007 while outermost back segment 1008 extends to an outermost back edge 1009. For example, each avatar could have five segments generated based on its positioning: one current segment 1010 for the current position of the avatar and two each for both the front and back segments 1012 and 1014. While two forward segments 1012 and two backward segments 1014 are illustrated in the embodiment above, one of ordinary skill in the art will now appreciate that any number of forward segments 1012 and backward segments 1014 can be generated. In some embodiments, current segment 1010 may include multiple segments where avatar B is within two or more segments at once, for example, where B is moving forward through the predetermined pathline transitioning from one segment to the next.

Because these segments are attributes related only to the avatars themselves, the segments associated with one avatar will not affect another avatar. For example, when avatar A approaches, from the upper left side, the intersecting area of the FIG. 8 configuration of path 1000 illustrated in FIG. 10, avatar B will not be prevented from entering into one of avatars A's segments and from moving forward when avatar B approaches the intersection from the upper right side.

As stated above, the segments, corresponding to the avatars, are generated based on the avatars positioning. When avatar B moves forward into the next segment towards outermost front segment 1006 from current segment 1010′ the next segment after current segment 1010 becomes the new current segment and the outermost back segment of back segment 1014 is removed. The outermost back segment then becomes the next back segment from the end. Accordingly, the first segment outside of the outermost front segment 1006 is generated and becomes the new outermost front segment. The advantage of generating and removing these segments based on the avatar's movement can be illustrated so that avatar A, after passing through the intersection in the FIG. 8 configuration of path 1000 from the upper left side, would not collide into its corresponding non-removed, leftover segments when attempting to pass through the FIG. 8 intersection from the lower left side.

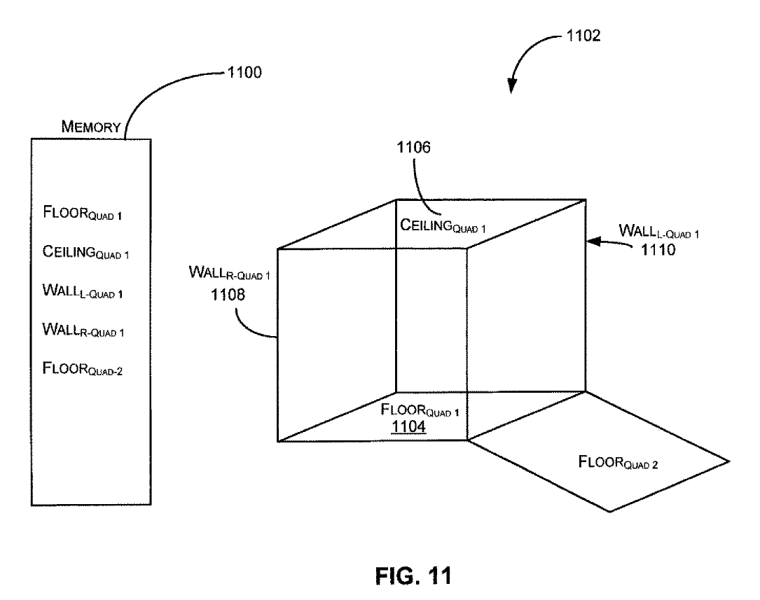

These segments of path 1000 are generated by calculating the location of avatar 206 to determine whether a new segment needs to be generated. If it is determined that a new segment is to be generated, the video game device 1 accesses a memory for the segment data, e.g., a memory 1100 illustrated in FIG. 11. In some embodiments, floor data for each segment can be stored in a different floor portion of memory (not illustrated). For example, a floor portion of memory 1100 may only store floor data for all segments. Accordingly, ceiling, right wall, and left wall data for all segments can be stored in their own respective different memory portions. In some embodiments, memory 1100 can store the floor, ceiling, and wall data of each segment sequentially, as illustrated in memory 1100 in FIG. 11. This alternative provides an efficient video game device 1 because video game device 1 will only have to access one portion of memory 1100 instead of four portions. After accessing the segment data provided in memory 1100, video game device 1 can generate a corresponding segment 1102 having a floor 1104, a ceiling 1106, a right wall 1108, and a left wall 1110, If it is determined that more segments are to be generated, video game device 1 can access memory 1100 for additional segment data.

### Controlling Camera Angle

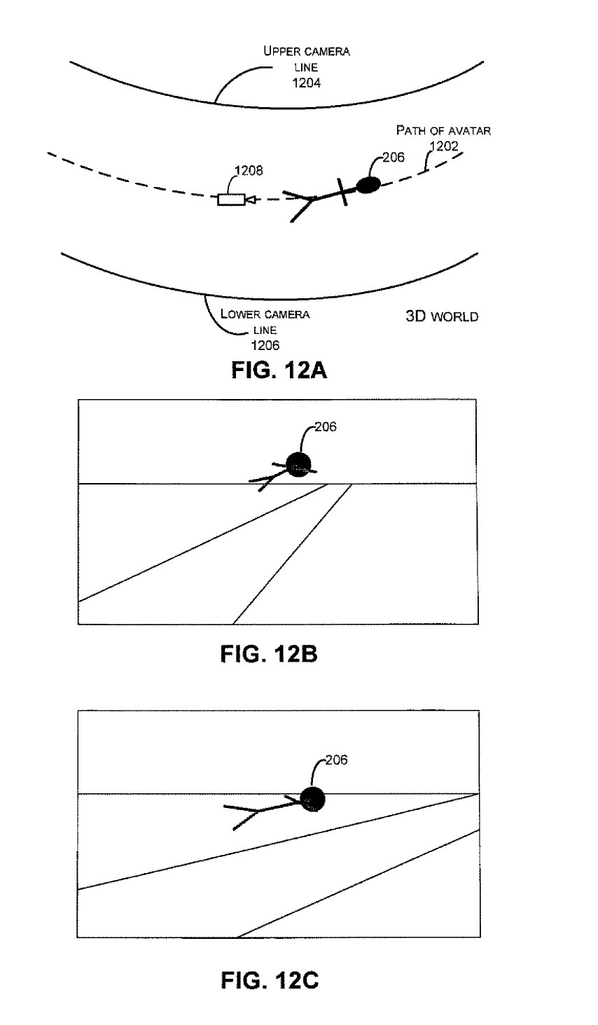

As provided above, some games require an avatar to travel in a three-dimensional (3D) world based on a predetermined path. The predetermined path is configured based on the X-axis and the Z-axis and avatar 206 can move freely in the direction of the Y-axis. In some embodiments, other characters within the game, except for the avatar that the player operates, can be moved in a predetermined path, irrespective of the 3 axes. For example, as illustrated in FIG. 12A, avatar 206 may fly through the 3D world based on this predetermined path 1202, which can be a path plane, having camera lines. Predetermined path 1202 can be further defined by an upper camera line 1204 and a lower camera line 1206. These camera lines 1204 and 1206 can correspond to barrier lines 804 and 806 illustrated in FIG. 8 or be completely unrelated to barrier lines 804 and 806. Within the game itself, in some embodiments, these lines would be invisible to the game player. In some embodiments, the predetermined path may also include a middle line. This middle line can be substantially in the middle between upper camera line 1204 and lower camera line 1206 or can be any predetermined path between upper camera line 1204 and lower camera line 1206 (and/or upper barrier line 804 and lower barrier line 806). The middle line provides a reference point to adjust a camera 1208 angle based on the position of avatar 206.

In some embodiments, a middle line can be eliminated and the video game device adjusts the camera angle based on the avatars position with respect to upper and lower camera lines 1204 and 1206. As avatar 206 gets closer to one camera line, while getting farther away from the other camera line, the angle of camera 1208 can increase towards the approaching camera line. In some embodiments, the camera angle could also be determined in such a way that a camera angle does not change until a certain ratio of the distances of the middle line and/or the camera line to the position of the avatar 206 is reached. Once this ratio threshold has been met, the camera angle may be changed. Alternatively, the camera angle may change in small angular increments until a certain ratio is reached and then after that the angle may change rapidly in an exponential fashion.

Further, the position of camera 1208 can be defined by the velocity of avatar 206 and the distance between the middle line and avatar 206. For example, as illustrated in FIG. 12B, if avatar 206 is moving at a high velocity, the angle of camera 1208 will follow avatar 206 giving the effect of avatar 206 moving at this high velocity. Accordingly, as illustrated in FIG. 12C, if avatar 206 moves at a lower velocity, the angle of camera 1208 can be more perpendicular to avatar 206. The angle of camera 1208 can be directly behind the character, perpendicular to, or at an angle horizontal to the position of avatar 206, as illustrated in FIGS. 12B and 12C. Because the position of the camera can be defined by the speed of avatar 206, a player may be able to easily locate items that are ahead of avatar 206.

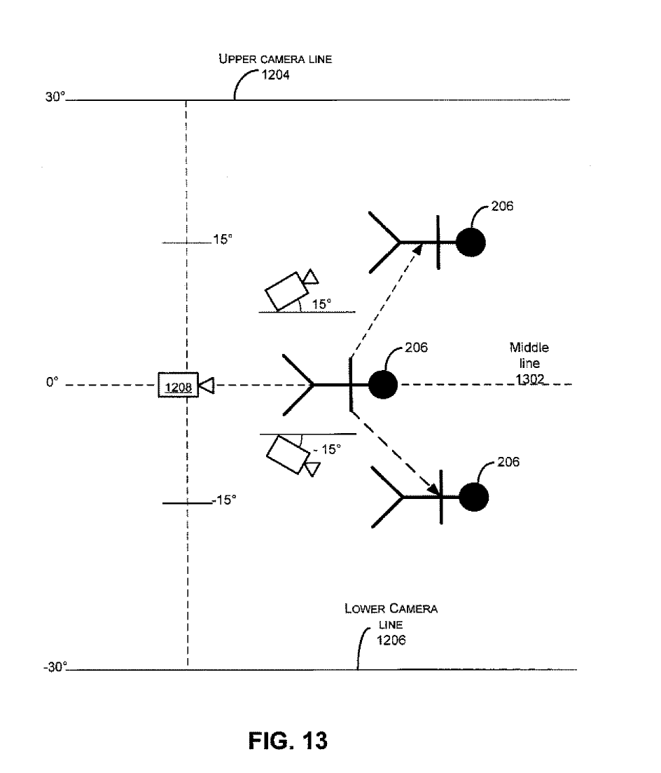

FIG. 13 illustrates an exemplary embodiment in which the predetermined path includes a middle line 1302. Middle line 1302 can refer to a 0° camera angle while upper camera line 1204 and lower camera line 1206 refer to 30° and −30° camera angles, respectively. If avatar 206 stays on middle line 1302 while traveling along the pathline, the camera can focus on the avatar from a 0° vertical angle. If avatar 206 moves along upper camera line 1204, the camera follows avatar 206 at a 30° angle. Accordingly, if avatar 206 moves along lower camera line 1206, camera 1208 follows avatar 206 at a −30° angle. The angle of camera 1208 adjusts accordingly based on the position of avatar 206 with respect to middle line 1302. For example, if avatar 206 is positioned halfway between middle line 1302 and upper camera line 1204, camera 1208 can follow avatar 206 at a 15° angle. Accordingly, if avatar 206 is positioned halfway between middle line 1302 and lower camera line 1206, camera 1208 can follow avatar 206 at a −15° angle. While 30° and −30° are illustrated as upper and lower camera lines 1204 and 1206, a person of ordinary skill in the art will now appreciate that any angle can be used for upper and lower camera lines 1204 and 1206 and the middle line 1302.

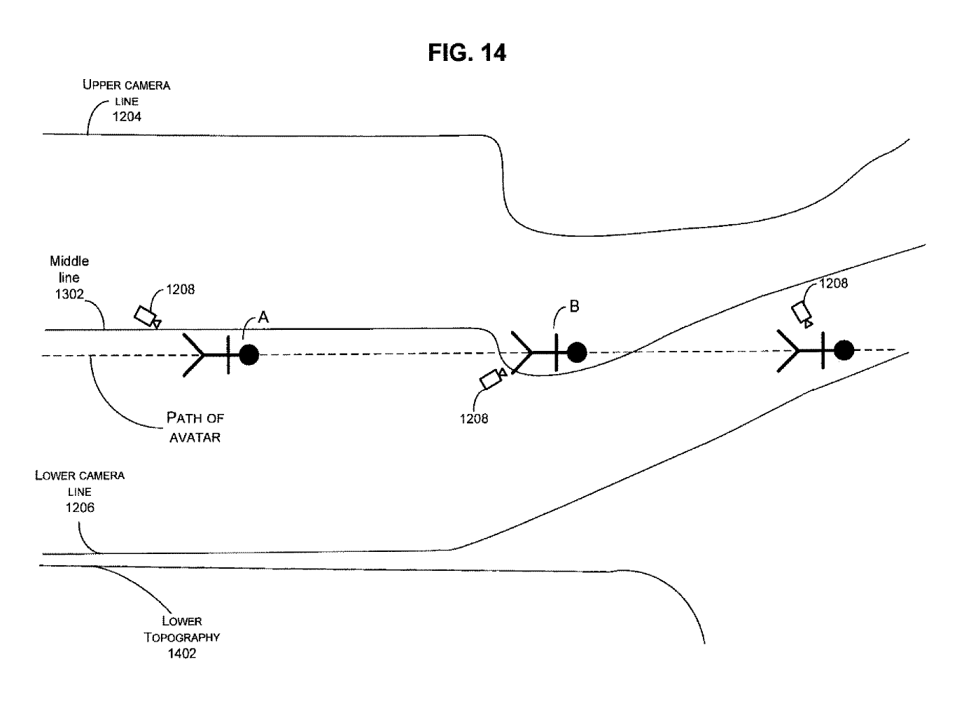

As shown in FIG. 14, middle line 1302 can be adjusted based on upper and lower camera lines 1204 and 1206 of the 3D world. For example, to illustrate sudden drops to a lower topography 1402, such as a cliff drop off, game designers may want to give the game player the effect of traveling over the cliff drop off even when avatar 206 does not move vertically within the pathline. Further, in some embodiments, the setting of upper and lower camera lines 1204 and 1206 can have no relationship to the topography of the 3D landscape, e.g., as illustrated between lower camera line 1206 and lower topography 1402. Furthermore, FIG. 14 illustrates that the camera angle can change even when avatar 206 maintains its course on the path.

While middle line 1302 has been illustrated above, other methods can be used for determining the camera angle based on the avatar's position. For example, instead of defining a predetermined path to include a middle line, the camera angle that follows avatar 206 can be based on the position of the avatar with respect to both upper and lower camera lines 1204 and 1206, which can be upper barrier line 804 and lower barrier line 806, respectively. For example, the angle may be based on a ratio comparing the distance between avatar 206 and upper camera line 1204 to the distance between avatar 206 and lower camera line 1206. For example, as avatar 206 approaches upper camera line 1204, the angle of camera 1208 can increase.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

In the preceding specification, the invention has been described with reference to specific exemplary embodiments. It will, however, be evident that various modifications and changes may be made without departing from the broader spirit and scope of the invention as set forth in the claims that follow. The specification and drawings are accordingly to be regarded as illustrative rather than restrictive. Other embodiments of the invention may be apparent to those skilled in the art from consideration of the specification and practice of the invention disclosed herein.

What is claimed is:

1. A method comprising;
sampling a controller's pointer position and tilt angle, wherein the pointer position is based on an interaction between the controller and a screen of a monitor;
calculating a center region tilt value based on the sampling;
calculating upper and lower tilt value limits based on the calculated center region tilt value; and
storing the calculated values so that a video game system can process a virtual pointer Y-axis value based on a game player's use of the controller.

2. A method comprising:
sampling a controller's pointer position and tilt angle, wherein the pointer position is based on an interaction between the controller and a screen of a monitor;
calculating a center region tilt value based on the sampling;
calculating upper and lower tilt value limits based on the calculated center region tilt value;
determining a Y-axis value based on the calculations;
determining an X-axis value based on the calculations; and
storing the determined X and Y-axis values so that a video game system can process a virtual pointer X-axis value and Y-axis value based on a game player's use of the controller.

3. The method of claim 1 or 2, wherein the sampling comprises operating an avatar based only on the one or more calculated tilt values when the pointer position cannot be sampled and the tilt angle can be sampled.

4. The method of claim 3, further comprising:
displaying a cursor on the screen of the monitor;
moving the cursor based on the tilt values; and
moving the avatar towards a direction of the displayed cursor, wherein moving the cursor allows the cursor to move within a cursor pathway.

5. The method of claim 4, wherein displaying the cursor comprises:
determining whether the pointer position can be sampled; and
changing a color of the cursor based on the determining.

6. A computer readable medium storing instructions that, when executed by a computer, cause the computer to perform a method for processing a position based on positioning of a controller, the method comprising:
sampling the controller's pointer position and tilt angle, wherein the pointer position is based on an interaction between the controller and a screen of a monitor;
calculating a center region tilt value based on the sampling;
calculating upper and lower tilt value limits based on the calculated center region tilt value; and
storing the calculated values so that a video game system can process a virtual pointer Y-axis value based on a game player's use of the controller.

7. A computer readable medium storing instructions that, when executed by a computer, cause the computer to perform a method for processing a position based on positioning of a controller, the method comprising:
sampling the controller's pointer position and tilt angle, wherein the pointer position is based on an interaction between the controller and a screen of a monitor;
calculating a center region tilt value based on the sampling;
calculating upper and lower tilt value limits based on the calculated center region tilt value;
determining a Y-axis value based on the calculations;
determining an X-axis value based on the calculations; and
storing the determined X and Y-axis values so that a video game system can process a virtual pointer X-axis value and Y-axis value based on a game player's use of the controller.

8. The computer readable medium of claim 6 or 7, wherein the sampling comprises operating an avatar based only on the one or more calculated tilt values when the pointer position cannot be sampled and the tilt angle can be sampled.

9. The computer readable medium of claim 8, further comprising instructions for:
displaying a cursor on the screen of the monitor;
moving the cursor based on the tilt values; and
moving the avatar towards a direction of the displayed cursor, wherein moving the cursor allows the cursor to move within a cursor pathway.

10. The computer readable medium of claim 9, wherein displaying the cursor comprises:
determining whether the pointer position can be sampled; and
changing a color of the cursor based on the determining.
